(19) United States
(12) Patent Application Publication
(10) Pub. No.: US 2019/0084054 A1
(43) Pub. Date: Mar. 21, 2019

(54) Coupling Device

(71) Applicant: Narr Beteiligungs GmbH, Zell u.A. (DE)

(72) Inventor: Paul Brosowsky, Deggingen (DE)

(21) Appl. No.: 16/132,486

(22) Filed: Sep. 17, 2018

(30) Foreign Application Priority Data
Sep. 15, 2017 (EP) 17191263.7

(51) Int. Cl. B23B 31/26; B23B 31/20

(52) U.S. Cl. CPC B23B 31/265; B23B 2231/2021; B23B 31/202

(57) ABSTRACT

A coupling device for coupling a hollow shaft taper to a receiver provided on the machine tool, having a collet and a tension rod by means of which the collet can be brought into a release position or a clamping position. The collet is embodied in one piece and has several clamping segments extending in its longitudinal direction. Upon moving the collet into the clamping position, said clamping segments are moved in a radial direction against spring forces exerted by the spring element. The spring elements are an integral part of the collet. Each spring element between two adjacent clamping segments is provided to extend in the longitudinal direction of the latter.

### CROSS REFERENCE TO RELATED APPLICATIONS

This application claims the priority of EP 17191263.7 filed on 2017 Sep. 15; this application is incorporated by reference herein in its entirety.

### BACKGROUND

The invention relates to a coupling device according to the preamble of claim 1.

Such a coupling device is known from EP 1 837 107 B1. This coupling device is used for coupling a hollow shaft taper to a receiver provided on the machine tool and comprises a collet having individual clamping segments and, at one end, at its outer circumference, an annular collar having a wedge-shaped annular surface. Additionally provided is a tension rod with a head having a radial ridge. This head pushes towards the clamping segments for clamping, with the clamping segments being deflected radially outward into the hollow shaft of the hollow shaft taper.

At its other end opposite the annular collar, the collet has an engagement collar having a radial surface that presses on a fixed axial support of a part of the receiver. The collet is made in one piece and provided at its rear part with an end-side ring that pivotably supports the collet on the tension rod on the inside and on an external support on the outside, with a thin-walled jacket section of the clamping segments, which forms a joint, being located adjacent to the ring. Radial deflection of the clamping segments is performed using the joints on the rear part of the collet.

In the rear part of the collet, the clamping segments have chambers for providing the clamping segments with the features of a spring cup.

The chambers thus form spring elements that generate the reset forces during the deflection of the clamping segments.

An advantage of this coupling device is that the collet is made in one piece; i.e., the number of parts can thus be kept low, significantly reducing the manufacturing effort and expense.

It is further advantageous that the one-piece collet can be manufactured to be exactly rotation-symmetrical, which allows achieving a high level of balance quality even at high rotational speeds.

A disadvantage of this coupling device is that it is very prone to wear. The chambers at the rear end of the collet, which have cup spring features and thus form spring elements, are especially wear-prone. These chambers are exposed to high mechanical loads, especially torsion loads. This usually results in premature breaking of these spring elements, undesirably reducing the lifespan of the collet.

### SUMMARY

The invention relates to a coupling device for coupling a hollow shaft taper to a receiver provided on the machine tool, having a collet and a tension rod by means of which the collet can be brought into a release position or a clamping position. The collet is embodied in one piece and has several clamping segments extending in its longitudinal direction. Upon moving the collet into the clamping position, said clamping segments are moved in a radial direction against spring forces exerted by the spring element. The spring elements are an integral part of the collet. Each spring element between two adjacent clamping segments is provided to extend in the longitudinal direction of the latter.

### DETAILED DESCRIPTION

The task of the invention is to provide a coupling device of the kind mentioned initially, which has a robust, wear-resistant construction while requiring low manufacturing effort and expense.

For solving this problem, the features of claim 1 are provided. Advantageous embodiments and useful further developments of the inventions are described in the dependent claims.

The coupling device according to the invention is used for coupling a hollow shaft taper to a receiver on the machine tool, with said device having a collet and a tension rod by means of which the collet can be brought into a release position or a clamping position. The collet is embodied in one piece and has several clamping elements extending in the collet's longitudinal direction. When the collet is moved into the clamping position, said clamping elements are moved in the radial direction against spring forces exerted by the spring element. The spring elements are an integral part of the collet. Each spring element between two adjacent clamping segments is provided to extend in the latters' longitudinal direction.

The coupling device according to the invention functions in that the collet is movable between a clamping position and a release position by actuating; i.e. shifting the tension rod. In the clamping position, the collet holds the hollow shaft taper in place in a target position on the receiver such that machining processes are performed using a tool supported in the hollow shaft taper. In contrast, in the release position of the collet, the hollow shaft taper is released and can be swapped, if applicable.

The basic idea of the invention consists in arranging the spring elements so that they extend in the longitudinal direction of the clamping segments as integral parts of the collet. Consequently, the spring elements embodied thus can have a great longitudinal extension, with these spring elements extending almost over the entire length or, especially advantageously, over the entire length of the clamping segments. As a result, the spring elements perform only very small deflection motions when the clamping segments are radially deflected, especially when the collet is moved into its clamping position. This, in turn, has the effect that the spring elements are exposed to merely low mechanical loads during the operation of the coupling device so that there is no wear worth mentioning of the spring elements even during long operating periods. Consequently, the collet has a long lifespan, thus realizing overall robust construction of the coupling device.

Another significant advantage results from the one-piece construction of the collet, which allows holding the number of individual parts of the coupling device low, minimizing the manufacturing effort and expense by allowing to produce the spring elements together with the clamping segments in one manufacturing step.

Further advantageous are the identically embodied clamping segments. And the spring elements are also embodied identically. Here, the clamping segments and the spring elements form a rotation-symmetrical arrangement relative to the longitudinal axis of the collet.

Due to the resulting complete rotation symmetry of the collet the latter has, contrary to a collet based on individual clamping segments, a high level of balance quality even at high rotational speeds. Thus, the coupling device is usable in HSC (high speed cutting); i.e., high speed machining. In addition, the collet can also be designed for high clamping forces.

Further advantageous is the simple contour of the collet, which has positive effects for the manufacturing process. Here, the shape of the collet is selected such that the collet meets the requirements of DIN 69063-S.

According to an advantageous embodiment of the invention, each clamping segment forms a joint at its rear end. These joints are supported in a recess in the receiver on the machine tool.

In addition, each clamping segment has at its front end a collar segment. The collar segment has a slanted surface against which rests a head of the tension rod. The collar segment further has a contact surface against which rests a segment of the hollow shaft taper.

Here, a spring element extends from the joint to the collar segment of a clamping segment.

Upon actuation of the tension rod, the clamping segments thus perform pivoting motions relative to the pivot axes running through the joints.

When the collet is moved into the clamping position, the contact areas of the collar segments of the clamping segments are brought in engagement with the hollow shaft taper so that the latter is held in place in the receiver.

When the collet is moved into the release position, the contact areas of the collar segments of the clamping segments are brought out of engagement with the hollow shaft taper, the reset forces of the spring elements moving the clamping segments into their original positions.

As the spring elements extend from the joints on the rear end of the collet to the collar segments at the front end, thus extending almost over the entire length of the clamping segments, the spring elements need to perform merely small deflection motions. In addition, this results in uniform force distribution via the spring elements. Thus, low spring element wear and accordingly long collet lifespans are achieved.

Especially advantageously, the spring elements embody leaf spring elements so that they are not exposed to torsion loads.

According to an embodiment of the invention that is particularly advantageous with regard to design, each spring element has two arms extending at a distance from each other. These arms are connected to each other at a longitudinal end of the spring element by means of a connecting web.

The resulting spring element is embodied in the shape of a mirror-symmetrical fork. The arms of the spring elements extend essentially in parallel at a distance from each other, with both arms being arranged in each space between two adjacent clamping segments. Here, each arm is molded to its associated clamping segment at the originally free arm end.

Each arm is connected to the associated clamping segment only by means of this molding at its free end. The rest of the arm extends at a distance from the clamping segment and is thus movably supported so that the arms are elastically deformable over almost their entire length. Thus, the forces are distributed over the entire length of the spring element when a force is applied. Due to the great length of the spring elements, merely small deflections of the arms will result upon impingement of a force; consequently, the spring element is not prone to wear.

### BRIEF DESCRIPTION OF THE DRAWINGS

The invention is explained below based on the drawings. The following is shown in:

FIG. 1: an exemplary embodiment of the coupling device according to the invention with a collet in its clamping position;

FIG. 2: an arrangement according to FIG. 1 with the collet in its release position;

FIG. 3: a first perspective view of the collet of the coupling device according to FIGS. 1 and 2;

FIG. 4: a second perspective view of the collet of the coupling device according to FIGS. 1 and 2;

FIG. 5: a cross-section view of the collet according to FIGS. 3 and 4;

FIG. 6: a first longitudinal section view of the collect according to FIGS. 3 and 4;

FIG. 7: a second longitudinal section view of the collect according to FIGS. 3 and 4.

### DETAILED DESCRIPTION OF THE PREFERRED EMBODIMENTS

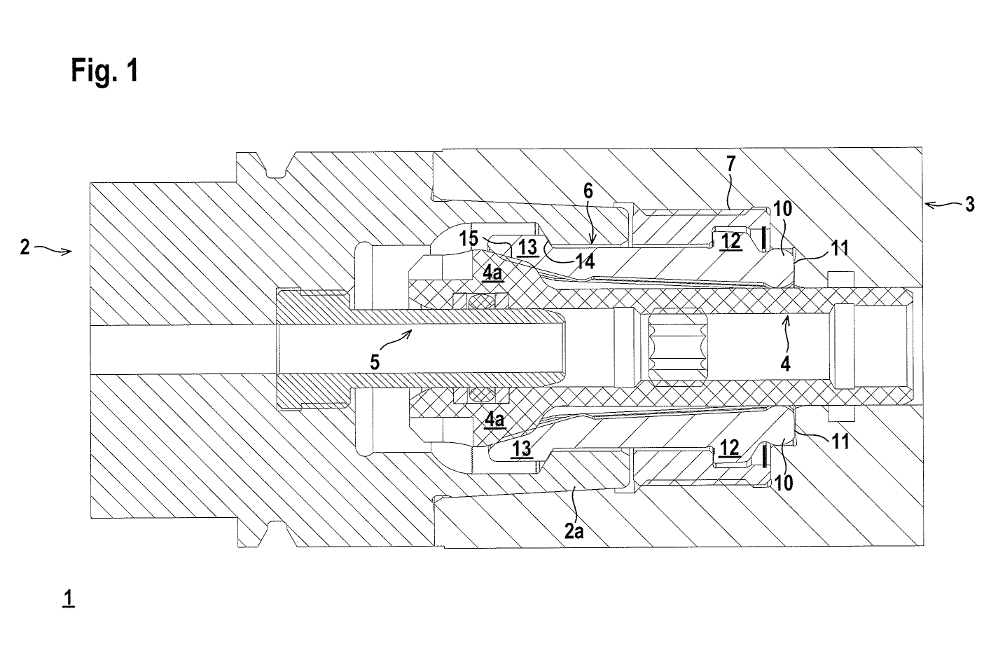

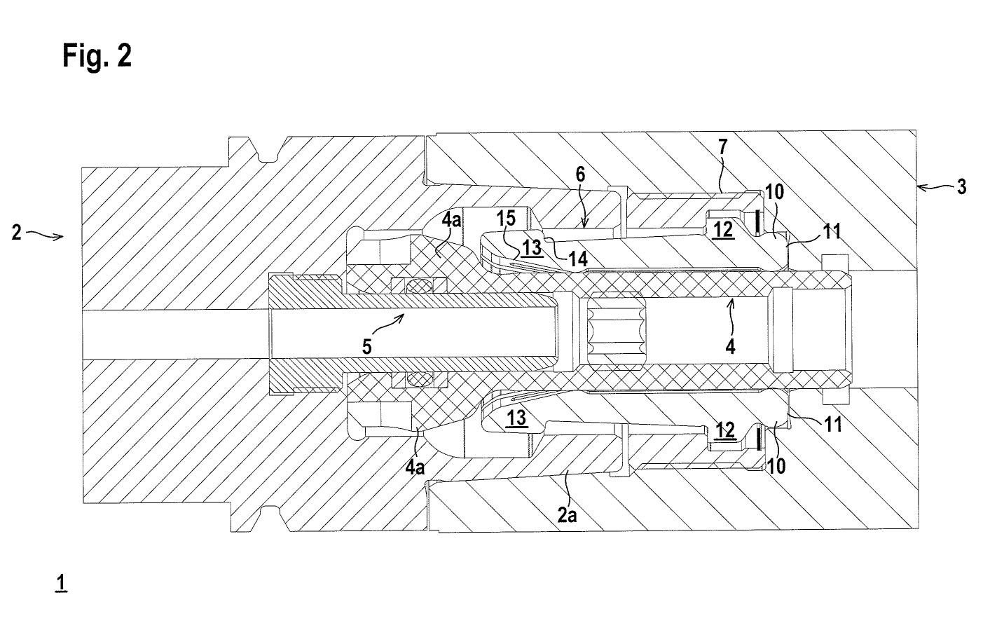

FIGS. 1 and 2 show an exemplary embodiment of the coupling device 1 according to the invention. The coupling device 1 is used for coupling a hollow shaft taper 2 to a receiver 3 of a machine tool. In the hollow shaft taper 2, a tool (not shown) can be supported.

The receiver 3 contains a through-bore in the axial direction, in which a tension rod 4 is shiftably supported in its longitudinal direction. The tension rod 4 has a head 4a at its front end.

The tension rod 4 is embodied in the shape of a hollow body, with a guide 5 of the hollow shaft taper 2 protruding into the hollow body. The tension rod 4 can thus slide on the guide 5, rendering said rod positively guided.

The coupling device 1 further has a collet 6, with a part of the collet 6 being supported in a sleeve 7 arranged in the receiver 3. By sliding the tension rod 4, the collet 6 is movable between a clamping position and a release position.

FIG. 1 shows the collet 6 in its clamping position. In this clamping position, the collet 6 is engaged with the tapered front part 2a of the hollow shaft taper 2, so that the hollow shaft taper 2 is held in place in its target position at the receiver 3. Thus, machining processes can be performed with a tool supported inside the hollow shaft taper 2.

FIG. 2 shows the collet 6 in its release position. In this release position, the collet 6 is no longer engaged with the tapered front part 2a of the hollow shaft taper 2, so that the hollow shaft taper 2 can now be removed from the receiver 3.

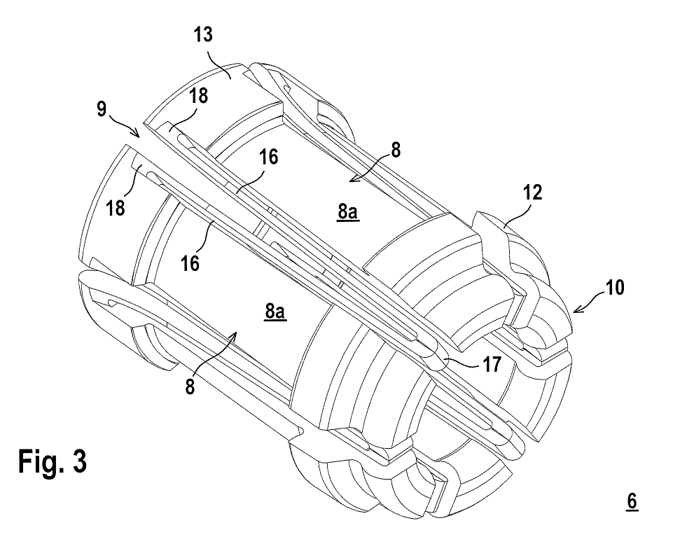

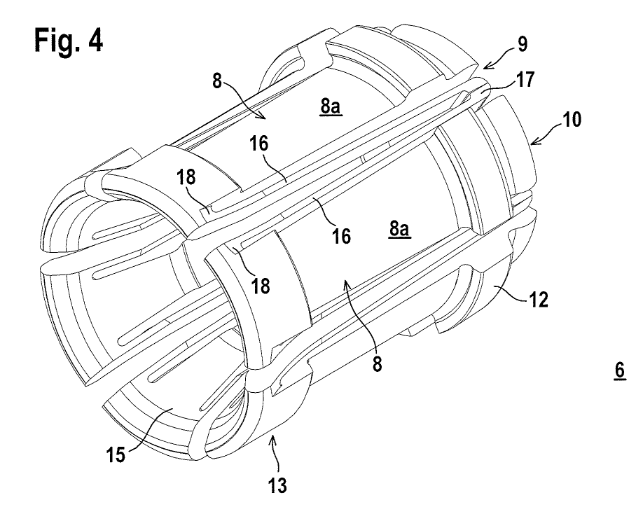

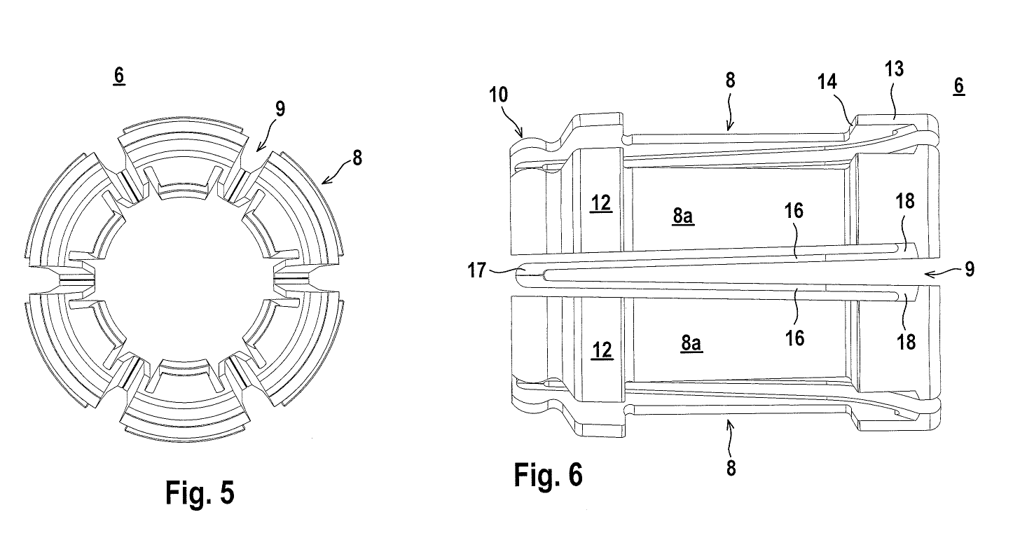

FIGS. 3 through 6 each show the collet 6 of the coupling device 1 in an individual view. As can be seen from these views, the collet 6 is embodied to be rotation-symmetrical relative to its longitudinal axis. The collet 6 has, in this case, six identically embodied clamping segments 8, which are connected solely by means of the spring elements 9, which are also identically embodied. The collet 6 can generally also have a different number of clamping segments 8 and spring elements 9. The collet 6 embodied thus is embodied in one piece and advantageously consists of a cast metal part.

The longitudinal axes of the clamping segments 8 run in parallel with each other and in parallel with the longitudinal axis of the collet 6.

Each clamping segment 8 has a central segment 8a having an essentially constant cross-section. The outer surfaces of these spacers of the clamping segments 8 lie on a cylindrical jacket surface of the collet 6.

At the rear end of each clamping segment 8, a joint 10 is embodied. This joint 10 is embodied in the shape of a broadened cross-section of the clamping segment 8. The joint 10 has a rounded contour. Each joint 10 is supported in a recess 11 in the receiver 3. Thus, each clamping segment 8 is pivotably supported in the receiver 3, with the pivot axis running through the joint 10.

At a small distance from the joint 10, an annular segment 12 abuts that protrudes from the outside of the central segment 8a of a clamping segment 8. The annular segments 12 of all the clamping segments 8 complement each other to form an annular structure which, as shown by FIGS. 1 and 2, rests against a step of the sleeve 7 when the joint 10 is inserted in the recess 11 of the receiver 3.

At the front end of each clamping segment 8, a collar segment 13 is provided that protrudes over the outside of the central segment. Here, at the border between the collar segment 13 and the central segment, a contact surface 14 in the shape of a step is embodied.

The inside of the collar segment 13 is embodied in the shape of a slanted surface 15. This slanted surface 15 matches the contour of the head 4a of the tension rod 4.

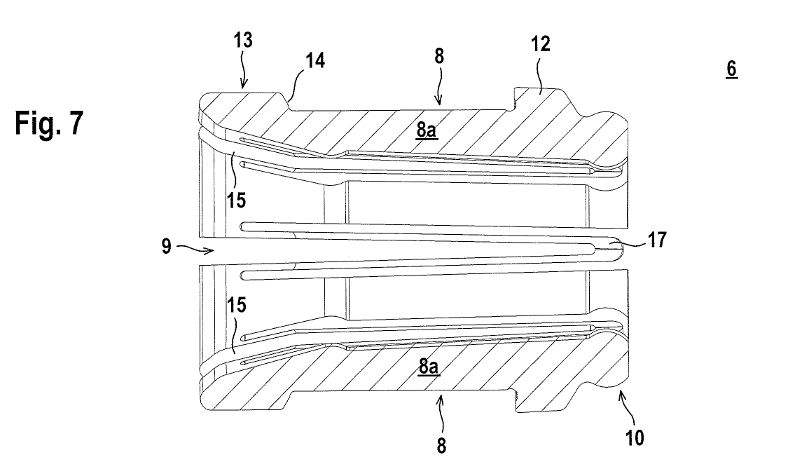

As shown in FIGS. 3 through 7, each spring element 9 extends in the space between two adjacent clamping segments 8. The spring element 9 extends in the longitudinal direction of the clamping segment 8 and extends here from the collar segment 13 to the joint 10 of a clamping segment 8, with the spring element 9 extending over the entire length of the clamping segment 8 in this case.

Generally, the spring element 9 can also extend merely over part of a clamping segment 8.

In this case, each spring element 9 is embodied as a leaf spring element. The spring element 9 embodied thus has two arms 16 extending essentially in parallel at a distance from each other and being connected at one of their longitudinal ends by means of a connecting web 17. The arms 16 are embodied to be mirror-symmetrical relative to a mirror plane. Each arm 16 is molded at its free end to its associated clamping element 16, with a bulge 18 which protrudes for this purpose on the free end of the arm 16 forming the connection to the clamping segment 8. Thus, each arm 16 extends, starting from this connecting spot, at a small distance from its associated clamping segment 8.

The mode of functioning of the collet 6 embodied thus in the coupling device 1 is such that when the collet 6 is moved into its clamping position by means of the tension rod 4 by inserting the head 4a of the tension rod 4 into the cavity of the collet 6, a force impinging radially from this head 4a is exerted on the slanted surfaces 15 of the clamping segments 8 such that these are pushed radially outward. Due to this, the clamping segments 8 perform pivoting motions relative to the pivot axis running through the joints 10. Here, the spring elements 9 are spread out, thus exerting reset forces countering this motion.

When, as the FIG. 1 shows, the clamping position of the collet 6 has been reached, the contact surfaces 14 of the clamping segments 8 rest against a step of the cone-shaped front part 2a of the hollow shaft taper 2, causing it to be held in place in the receiver 3.

When the tension rod 4 is then moved back in order to release the hollow shaft taper 2, the clamping segments 8 return into their original position due to the return forces of the spring elements 9. The collet 6 is then in the release position shown in the FIG. 2, in which it releases the hollow shaft taper 2.

### LIST OF REFERENCE NUMERALS

(1) coupling device
(2) hollow shaft taper
(2a) front part
(3) receiver
(4) tension rod
(4a) head
(5) guide
(6) collet
(7) sleeve
(8) clamping segment
(8a) segment
(9) spring element
(10) joint
(11) recess
(12) annular segment
(13) collar segment
(14) contact surface
(15) slanted surface
(16) arm
(17) connecting web
(18) bulge

1. A coupling device (1) for coupling a hollow shaft coupling (2) to a receiver (3) provided on the machine tool side, having a collet (6) and a tension rod (4) by means of which the collet (6) can be moved into a release position of a clamping position, with the collet (6) being embodied in one piece and having several clamping elements (8) extending in its longitudinal direction, with said clamping elements, upon moving of the collet (6) into the clamping position, being moved in a radial direction against spring forces exerted by the spring element (9), with the spring elements (9) being an integral part of the collet (6), characterized in that each spring element (9) is provided to extend between two adjacent clamping segments (8) in their longitudinal direction.

2. The coupling device (1) according to claim 1, characterized in that the clamping segments (8) are embodied identically.

3. The coupling device (1) according to claim 1, characterized in that the spring elements (9) are embodied identically.

4. The coupling device (1) according to claim 1, characterized in that the clamping segments (8) and the spring elements (9) form a rotation-symmetrical arrangement relative to the longitudinal axis of the collet (6).

5. The coupling device (1) according to claim 1, characterized in that each clamping segment (8) forms a joint (10) at its rear end.

6. The coupling device (1) according to claim 1, characterized in that each clamping segment (8) has at its front end a collar segment (13), with the collar segment (13) having a slanted surface (15) against which rests a head (4a) of the tension rod (4), and with the collar segment (13) having a contact surface (14) against which rests a segment of the hollow shaft coupling (2).

7. The coupling device (1) according to claim 6, characterized in that a spring element (9) extends from the joint (10) to the collar segment (13) of a clamping segment (8).

8. The coupling device (1) according to claim 1, characterized in that the spring elements (9) extend over the entire length of the clamping segments (8).

9. The coupling device (1) according to claim 1, characterized in that the spring elements (9) embody leaf spring elements.

10. The coupling device (1) according to claim 1, characterized in that each spring element (9) has two arms at a distance from each other that are connected with each other by means of a connecting web (17) at a longitudinal end of the spring element (9).

11. The coupling device (1) according to claim 10, characterized in that one arm (16) each is arranged on the edge of a clamping segment (8) of two adjacent clamping segments (8).

12. The coupling device (1) according to claim 11, characterized in that each arm (16) is molded at its free end to the associated clamping segment (8).

13. The coupling device (1) according to claim 10, characterized in that the spring element (9) embodies a mirror-symmetrical arrangement with its two arms (16).
